(19) United States
(12) Patent Application Publication
(10) Pub. No.: US 2014/0310000 A1
(43) Pub. Date: Oct. 16, 2014

(54) SPOTTING AND FILTERING MULTIMEDIA

(71) Applicant: NEXIDIA INC., Atlanta, GA (US)

(72) Inventors: Peter S. Cardillo, Atlanta, GA (US); Scott A. Judy, Newnan, GA (US); Maria Kunin, El Cerrito, CA (US)

(73) Assignee: Nexidia Inc., Atlanta, GA (US)

(21) Appl. No.: 13/863,700

(22) Filed: Apr. 16, 2013

(51) Int. Cl. H04M 3/493; G10L 21/00

(52) U.S. Cl. CPC H04M 3/4936; G10L 21/00
USPC 704/270.1

(57) ABSTRACT

In an aspect, in general, a computer implemented method includes receiving a query phrase, receiving a first data representing a first audio signal including an interaction among a number of speakers and at least one segment of one or more known audio items, receiving a second data comprising temporal locations of the at least one segment of one or more known audio items in the first audio signal, and searching the first data to identify putative instances of the query phrase that are temporally excluded from the temporal locations of the at least one segment of one or more known audio items.

### BACKGROUND

This invention relates to spotting occurrences of multimedia content and filtering search results based on the spotted occurrences.

In conventional speech analytics frameworks, queries are specified by users of the framework for the purpose of extracting information from audio recordings. For example, a customer service call center may store audio recordings of conversations between customer service agents and customers for later analysis by a speech analytics framework. Subsequently, a user of the speech analytics framework may specify queries to ensure that the customer service provided to the customer by the agent was satisfactory.

Many audio recordings such as audio recordings of customer service call center conversations also include known audio items such as hold messages or interactive voice response (IVR) messages.

### SUMMARY

In an aspect, in general, a computer implemented method includes receiving a query phrase, receiving a first data representing a first audio signal including an interaction among a number of speakers and at least one segment of one or more known audio items, receiving a second data comprising temporal locations of the at least one segment of one or more known audio items in the first audio signal, and searching the first data to identify putative instances of the query phrase that are temporally excluded from the temporal locations of the at least one segment of one or more known audio items.

Aspects may include one or more of the following features.

The method may also include determining the second data including receiving the first data representing the first audio signal, receiving a third data characterizing one or more known audio items, and searching the first data for the data characterizing one or more known audio items to identify temporal locations of the at least one segment of one or more known audio items in the first audio signal. The steps of searching the first data for the data characterizing one or more known audio items and searching the first data to identify putative instances of the query phrase may be performed concurrently.

Searching the first data to indentify putative instances of the query phrase which are temporally excluded from the temporal locations of the at least one segment of one or more known audio items may include searching the entire audio signal to identify putative instances of the query phrase and disregarding at least some of the identified putative instances of the query phrase that have a temporal location coinciding with the temporal locations of the at least one segment of one or more known audio items. Searching the first data to indentify putative instances of the query phrase that are temporally excluded from the temporal locations of the at least one segment of one or more known audio items may include searching only the parts of the first data that are excluded from the temporal locations of the at least one segment of one or more known audio items.

Each of the temporal locations of the at least one segment of one or more known audio items may include a time interval indicating a start time and an end time of a segment of an associated known audio item. Each of the temporal locations of the at least one segment of one or more known audio items may include a timestamp indicating a start time of a segment of an associated known audio item and a duration of the segment of the associated known audio item. Searching the first data to identify putative instances of the query phrase may include performing a phonetic searching operation on the first data. Performing the phonetic searching operation may include performing a wordspotting operation.

Disregarding at least some of the identified putative instances of the query phrase which have a temporal location coinciding with the temporal locations of the at least one segment of one or more known audio items may include removing portions of the first audio signal which are associated with the temporal locations of the at least one segment of one or more known audio items prior to identifying putative instances of the query phrase. Disregarding at least some of the identified putative instances of the query phrase which have a temporal location coinciding with the temporal locations of the at least one segment of one or more known audio items may include marking portions of the first audio signal which are associated with the temporal locations of the at least one segment of one or more known audio items; and skipping the marked sections when identifying the putative instances of the query phrase. The one or more known audio items may include hold messages and interactive voice response (IVR) messages. The hold messages and IVR messages may be automatically inserted into the first audio signal at a call center.

In another aspect, in general, a system includes an input for receiving a query phrase, an input for receiving a first data representing a first audio signal comprising an interaction among a number of speakers and at least one segment of one or more known audio items, an input for receiving a second data comprising temporal locations of the at least one segment of one or more known audio items in the first audio signal, a speech processing module for searching the first data to identify putative instances of the query phrase, and a filtering module for disregarding at least some of the identified putative instances of the query phrase which have a temporal location coinciding with the temporal locations of the at least one segment of one or more known audio items.

Aspects may include one or more of the following features.

The system may further include a multimedia spotting module for determining the second data including receiving the first data representing the first audio signal, receiving a third data characterizing one or more known audio items, and searching the first data for the data characterizing one or more known audio items to identify temporal locations of at least one segment of the one or more known audio items in the first audio signal. Each of the temporal locations of the at least one segment of one or more known audio items may include a time interval indicating a start time and an end time of a segment of an associated known audio item. Each of the temporal locations of the at least one segment of one or more known audio items may include a timestamp indicating a start time of a segment of an associated known audio item and a duration of the segment of the associated known audio item. The searching module may be a phonetic searching module configured perform a phonetic searching operation on the first data.

The searching module may be a wordspotting engine configured to perform a wordspotting operation on the first data. The filtering module may be configured to disregard at least some of the identified putative instances of the query phrase which have a temporal location coinciding with the temporal locations of the at least one segment of one or more known audio items including removing portions of the first audio signal which are associated with the temporal locations of the at least one segment of one or more known audio items prior to identifying putative instances of the query phrase. The filtering module may be configured to disregard at least some of the identified putative instances of the query phrase which have a temporal location coinciding with the temporal locations of the at least one segment of one or more known audio items including marking portions of the first audio signal which are associated with the temporal locations of the at least one segment of one or more known audio items; and skipping the marked sections when identifying the putative instances of the query phrase.

The one or more known audio items may include hold messages and interactive voice response (IVR) messages. The hold messages and IVR messages may be automatically inserted into the first audio signal at a call center.

In another aspect, in general, software stored on a computer readable medium includes instructions for causing a data processing system to receive a query phrase, receive a first data representing a first audio signal comprising an interaction among a plurality of speakers and at least one segment of one or more known audio items, receive a second data comprising temporal locations of the at least one segment of one or more known audio items in the first audio signal, search the first data to identify putative instances of the query phrase, and disregard at least some of the identified putative instances of the query phrase which have a temporal location coinciding with the temporal locations of the at least one segment of one or more known audio items.

Other features and advantages of the invention are apparent from the following description, and from the claims.

### DESCRIPTION OF DRAWINGS

FIG. 1 illustrates a telephone conversation between a customer and a customer service agent at a call center.

FIG. 2 is a multimedia spotting system.

FIG. 3 is a first speech analytics system including a search result filter.

FIG. 4 is a second speech analytics system including a call record filter.

FIG. 5 is an example of the speech analytics system in use.

FIG. 6 is an example of one embodiment of the searching and filtering module in use.

### Description

### 1 Overview

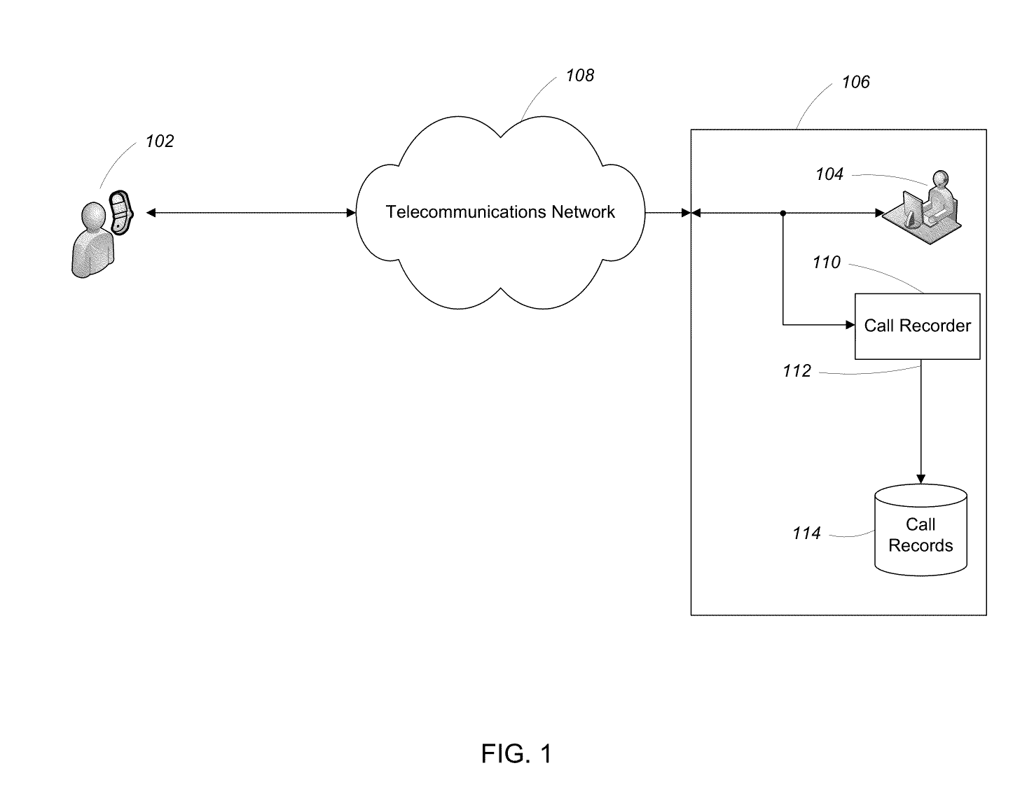

Referring to FIG. 1, a conversation between a customer 102 and a customer service agent 104 at a customer service call center 106 takes place over a telecommunications network 108. A call recorder 110 at the call center 106 monitors and records the conversation to a database of call records 114.

In general, the conversation between the customer 102 and the agent 104 includes verbal transactions between the two parties (102, 104) and messages (e.g., recorded speech or music) which are injected into the conversation by the call center 106. In some examples, the call center 106 may inject music or a hold message into the conversation while the agent 104 is busy performing a task. In other examples, the call center 106 may inject messages prompting the customer 102 to provide some input to the call center 106. For example, the call center 106 may prompt the customer 102 to dial in or speak their social security number.

As is described above, the recorded conversations which are stored in the database of call records 114 may recalled and analyzed by a speech analytics system to monitor customer satisfaction and customer service quality. The analysis of the calls generally involves a user of the speech analytics system specifying one or more queries which are then used by a speech recognizer of the speech analytics system to identify instances of the queries in the recorded conversation.

In some examples, the messages injected into the conversation by the call center 106 include words, phrases, or sounds which are phonetically similar to the query terms specified by the user. This can result in the speech analytics system identifying instances of the queries in the injected messages. In some examples, such identifications of instances of the queries in the injected messages are an annoyance to the user of the speech analytics system who is likely not interested in the content of the injected message. In other examples, the contents of a new message which is injected into the conversation may cause many identifications of the query, swamping the identifications of the query which occur in the verbal transactions between the customer 102 and the agent 104. Thus, there is a need for a speech analytics system which is capable of locating messages injected by the call center 106 and disregarding or otherwise specially processing instances of the query which are located within the injected messages.

### 2 Speech Analytics System

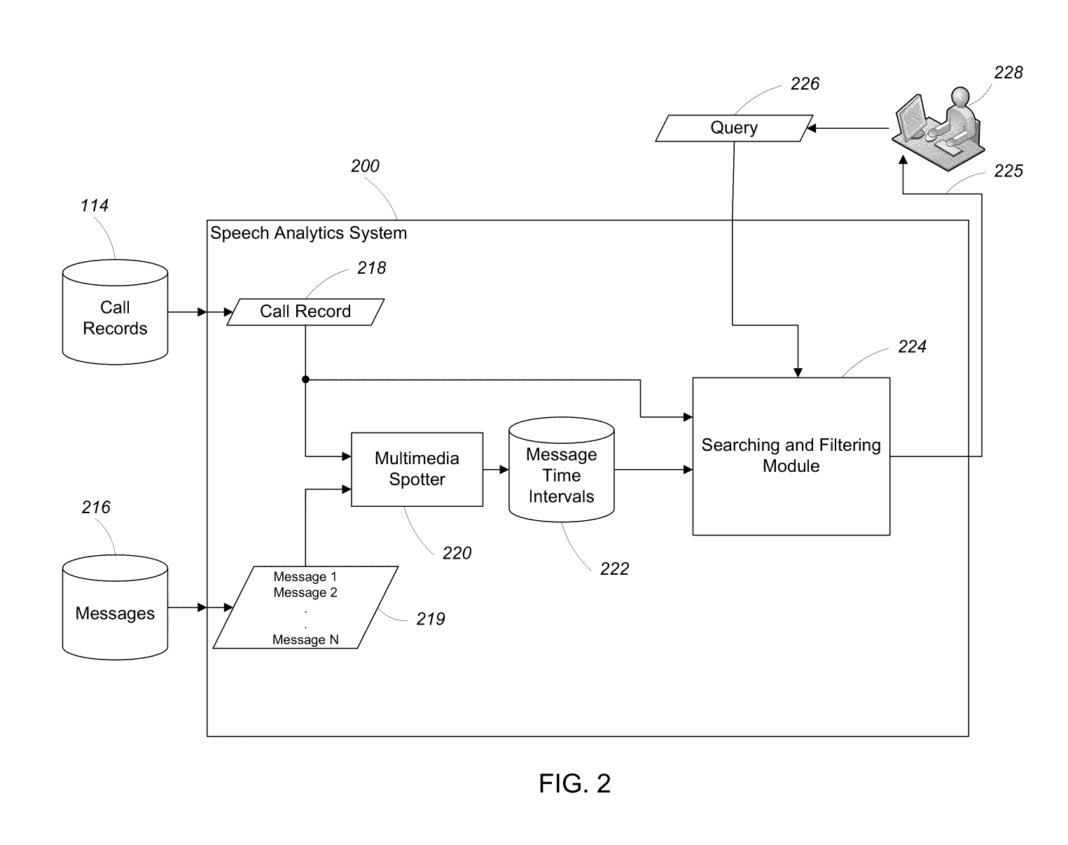

Referring to FIG. 2, a speech analytics system 200 receives a query 226 from a user 228, the database of call records 114, and a database of call center messages 216 as input. The speech analytics system 200 processes the inputs to generate search results 225 which are provided to the user 228. In general, the search results 225 include one or more putative instances of the query 226 and an associated location in a call record for each putative instance. Any putative instances of the query 226 which coincide with a call center message included in the call record 218 are excluded from the search results 225 by the speech analytics system 200.

In some examples, the speech analytics system 200 includes a multimedia spotter 220, and a searching and filtering module 224. The multimedia spotter 224 receives the call record 218 from the database of call records 114 and a number of call center items or messages 219 from the database of call center messages 216. The multimedia spotter 220 analyzes the call record 218 to identify instances of the call center messages 219 which are included in the call record 218. The multimedia spotter 220 forms a set of message time intervals 222 which includes the time intervals in which the identified call center messages are located in the call record 218. For example, the set of message time intervals 222 may include information indicating that “Message 2” of the number of call center messages 219 was identified as beginning at the 2 min 30 second point and ending at the 3 minute 00 second point of the call record 218. In some examples, the set of message time intervals 222 may include a start point and duration of each identified call center message.

In some examples, the multimedia spotter 220 is capable of identifying segments of the call center messages 219 (i.e., a portion of a call center messages that has a size less than or equal to the total size of the call center message) in the call record. For example, the call center messages 219 can be provided to the multimedia spotter 220 as a catalog of features of media (i.e., call center messages or items). The multimedia spotter 220 can identify segments of the call record which match the cataloged features of a subset or even an entire call center message. In some examples, a decision is made as to whether a segment of the call record that matches cataloged features of one or more call center messages is positively identified as a clip of a call center message. For example, a decision may be made based on a confidence score associated with the identified segment or based on a duration of the identified segment.

In some examples, the multimedia spotter 220 performs identification of the number of messages 219 in the call record 218 according to the multimedia clip spotting systems and methods described in U.S. Patent Publication 2012/0010736 A1 titled “SPOTTING MULTIMEDIA” which is incorporated herein by reference.

The set of message time intervals 222 is passed to the searching and filtering module 224 along with the call record 218 and the query 226. As is described in more detail below, the searching and filtering module 224 generates search results 225 by identifying putative instances of the query 226 in time intervals of the call record 218 which are mutually exclusive with the time intervals identified in the set of message time intervals 222. The search results 225 are passed out of the speech analytics system 200 for presentation to the user 228.

It is noted that in some examples, the multimedia spotter 220 analyzes the call record 218 and the number of call center messages 219 one time and stores the set of message time intervals 222 in a database outside of the speech analytics system 200 (not shown). The speech analytics system 200 then reads the set of message time intervals 222 from the database and uses those time intervals when searching the call record 218 for putative instances of the query 226 rather than re-computing the set of message time intervals 222.

### 2.1 Searching and Filtering Module

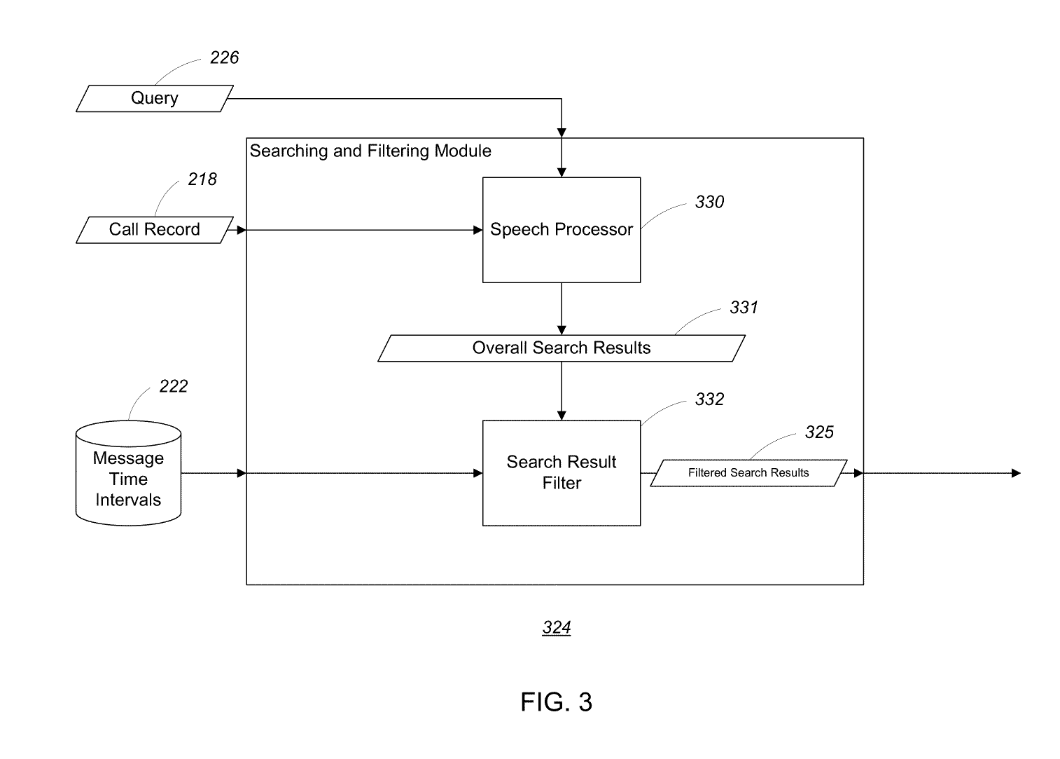

Referring to FIG. 3, a first example of the searching and filtering module 324 receives the query 226, the call record 218, and the set of message time intervals 222 (as shown in FIG. 2) as inputs. The searching and filtering module 324 processes the inputs to determine filtered search results 325.

The searching and filtering module 324 includes a speech processor 330 and a search result filter 332. In general, the speech processor 330 receives the query 226 and the call record 218 as inputs. The speech processor 330 processes the call record 218 to form overall search results 331 by identifying putative instances of the query 226 in the call record 218. It is noted that a “putative instance” of the query 226 is defined herein as a temporal location (or a time interval) of the call record 218 which includes, with some measure of certainty, an instance of the query 226. Thus, a putative instance of a query 226 generally includes a confidence score indicating how confident the speech processor 330 is that the putative instance of the query 226 is, in fact, an instance of the query 226. In some examples, putative instances of the query 226 are identified using a wordspotting engine. One implementation of a suitable wordspotting engine is described in U.S. Pat. No. 7,263,484, “Phonetic Searching,” issued on Aug. 28, 2007, the contents of which are incorporated herein by reference.

In this example, each identified putative instance of the query 226 is associated with a time interval indicating the temporal location of the putative instance in the call record 218. The overall search results 331 and the set of message time intervals 222 are passed to the search result filter 332 which filters the overall search results 331 according to the set of message time intervals 222. In some examples, the search result filter 332 compares the temporal locations of the putative instances included in the overall search results 331 to the time intervals which are identified in the set of message time intervals 222 as including call center messages. Any putative instances of the query 226 in the overall search results 331 which have a temporal location that intersects with a time interval of any of the call center messages in the set of message time intervals 222 are removed (i.e., filtered) from the overall search results 331, resulting in filtered search results 325. The filtered search results 325 are passed out of the searching and filtering module 324 for presentation to the user.

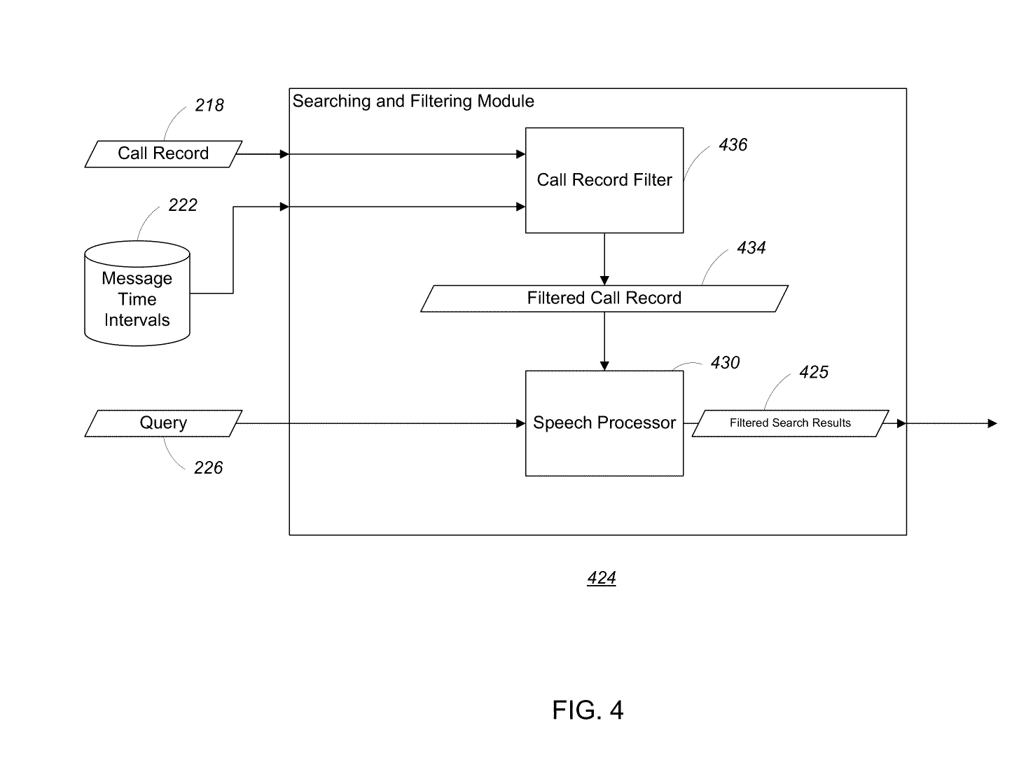

Referring to FIG. 4, a second example of the searching and filtering module 424 receives the query 226, the call record 218, and the set of message time intervals (as shown in FIG. 2) as inputs. The searching and filtering module 424 processes the inputs to determine filtered search results 425.

The searching and filtering module 424 includes a call record filter 436 and a speech processor 430. In general, the call record filter 436 receives the call record 218 and the set of message time intervals 222 as inputs and processes the call record 218 according to the set of message time intervals 222. In some examples, for each time interval included in the set of message time intervals 222 (i.e., indicating the location of a call center message in the call record 218), the call record filter 436 removes a section of the call record 218 temporally located at the time interval. In other examples, for each time interval included in the set of message time intervals 222 (i.e., indicating the location of a call center message in the call record 218), the call record filter 436 flags a section of the call record 218 temporally located at the time interval such that the speech processor 430 knows to skip that section when processing the call record 218. The result of the call record filter 436 is a filtered call record 434.

The filtered call record 434 is passed to the speech processor 430 which forms filtered search results 425 by identifying putative instances of the query 226 in the filtered call record 434. In the case where sections of the call record 218 are removed according to the set of message time intervals 222, the speech processor 430 generates filtered search results 425 including all putative instances of the query 226 found in the filtered call record 434. In the case where the sections of the call record 218 are flagged according to the set of message time intervals 222, the speech processor 430 generates filtered search results 425 by identifying putative occurrences of the query 226 only in the sections of the filtered call record 434 which are not flagged. The filtered search results are passed out of the searching and filtering module 324 for presentation to the user.

In some examples, the searching and filtering module 224 decides whether to exclude segments identified as being associated with call center messages from the search results based on, for example, a confidence score associated with the identified segment or based on a duration of the identified segment.

### 3 Example

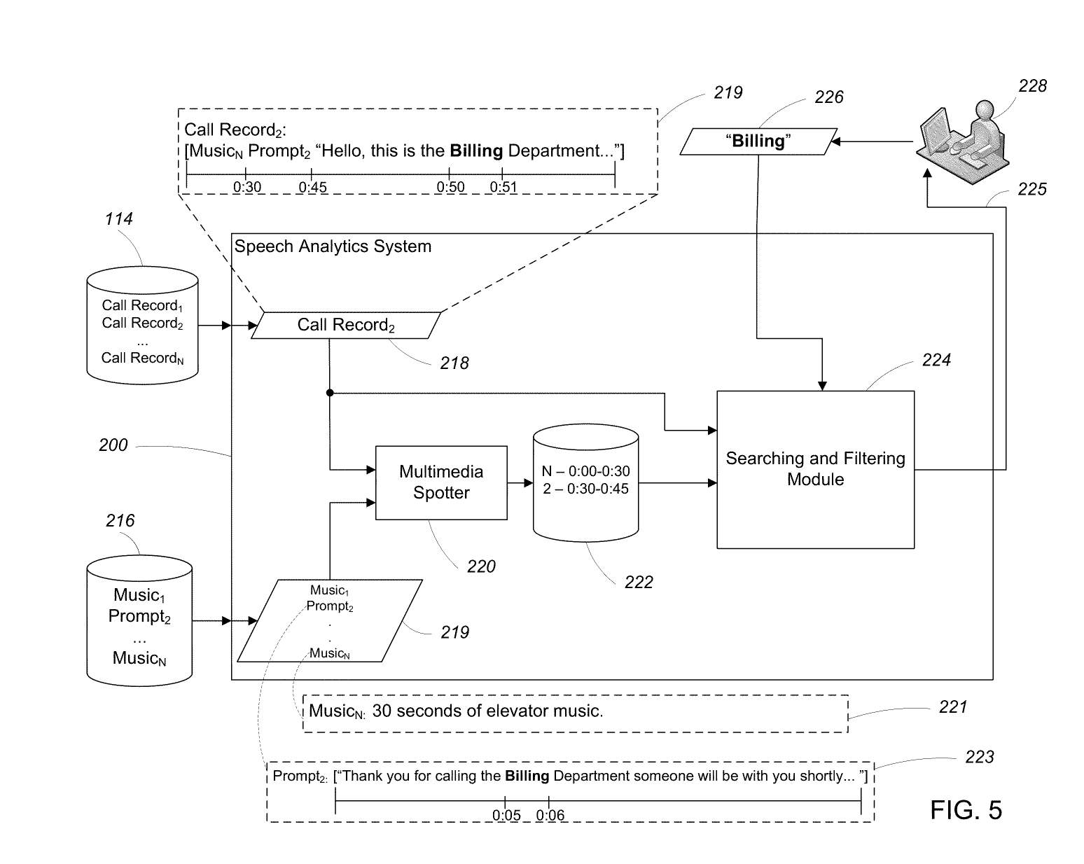

Referring to FIG. 5, an example of the operation of the speech analytics system 200 of FIG. 2 receives a query 226 from a user 228, a database of call records 114, and a database of call center messages 216 as input. The speech analytics system 200 processes the inputs to generate search results 225 which are provided to the user 228.

In this example, the user 228 has specified the query 226 as the word “Billing,” indicating that the system should search for putative instances of the word “Billing” in one or more of the call records from the database of call records 114.

The speech analytics system 200 may search all of the call records in the database of call records for putative instances of the word “Billing.” However, the Example of FIG. 5 illustrates this search process for a single call record (i.e., Call Record₂ 218 of the database 114). An expanded view 219 of Call Record₂ 218 illustrates that the content of the call record 218 includes 30 seconds of music, followed by a 15 second user prompt, followed by a conversation between a call center agent and a customer. In the conversation between the call center agent and the customer, the word “Billing” is uttered in the time interval from 0:50 to 0:51 of the call record 218.

The 30 seconds of music and the 15 second user prompt of the call record 218 are sections of the call record 218 which were automatically added by the call center. Thus, these sections of the call record 218 are also represented in the database of call center messages 216 as Music_{N} and Prompt₂. An expanded view of the Music_{N} message 221 illustrates that Music_{N} includes only music (i.e., 30 seconds of elevator music) and has no speech content. An expanded view of the Prompt₂ message 223 illustrates that Prompt₂ includes the speech “Thank you for calling the Billing Department someone will be with you shortly.” Note that the query term 227 “Billing” is included in a time interval from 0:05 to 0:06 of the Prompt₂ message.

As is described above, the user 228 is not interested in finding instances of the term “Billing” in call center messages. Rather, the user 228 is only interested in finding instances of “Billing” in the conversation between the call center agent and the customer. However, performing a brute force search on the call record 218 would result in two putative instances of the word “Billing,” one in the conversation, and another in a call center message. To avoid such an undesirable situation, the speech analytics system 200 is configured to find putative instances of the word “Billing” in time intervals of the call record 218 which are not related to the call center messages included in the database of call center messages 216.

To do so, the call record 218 is first passed to a multimedia spotter 220. The multimedia spotter 220 identifies any time intervals of the call record 218 which are associated with the messages included in the database of call center messages 216. In the present example, the multimedia spotter 220 has identified that the call center message Music_{N} is present in the time interval from 0:00 to 0:30 in the call record 218. The multimedia spotter 220 has also identified that the Prompt₂ call center message is present in the time interval from 0:30 to 0:45 of the call record 218. The results of the multimedia spotter 220 are stored as a set of message intervals 222.

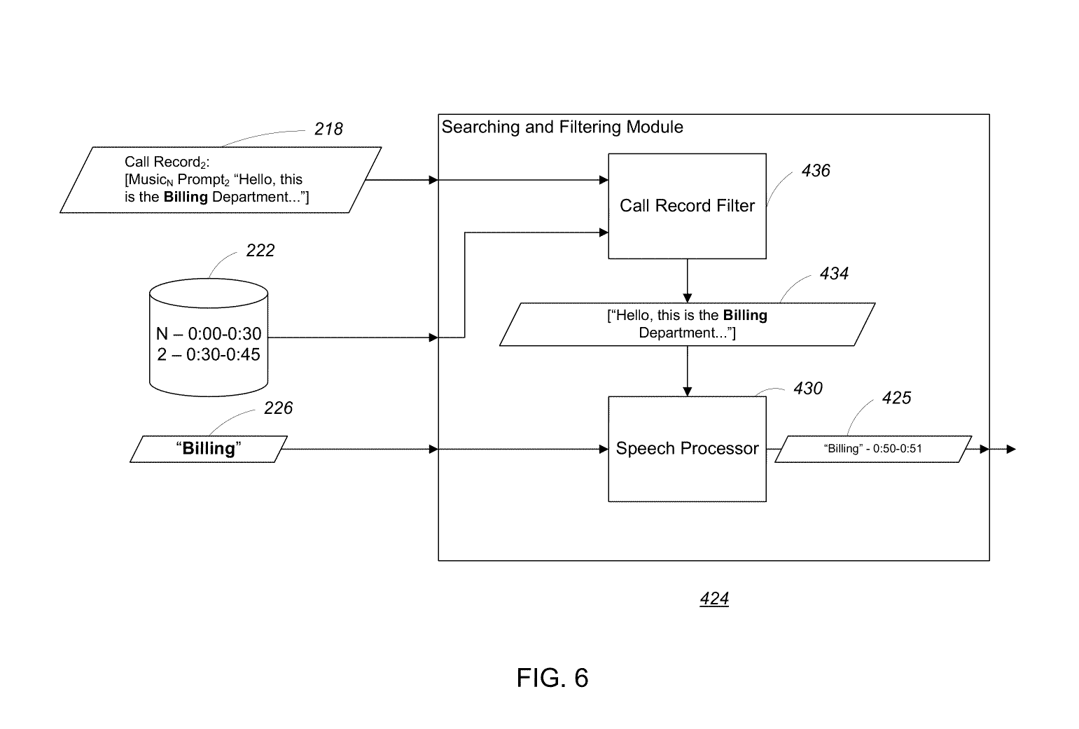

The query 226, the call record 218, and the set of message intervals 222 are then passed to a searching and filtering module 224 as inputs. Referring to FIG. 6, the searching and filtering module 424 receives the inputs and passes the call record 218 and the set of message intervals 222 to a call record filter 436. The call record filter generates a filtered call record 434 by removing the time intervals included in the set of message intervals 222 from the call record 218. In some examples, the time intervals are removed by adding silence to the call record 218 in the time intervals (thereby preserving the time index of the call record 218). In other examples, the time intervals are removed from the call record by cutting the timer intervals out of the call record 218 and keeping track of the time index of the call record 218. The resulting filtered call record 434 has the call center messages (i.e., Music_{N} and Prompt₂) removed and includes only the conversation between the customer service agent and the customer (i.e., “Hello, this is the Billing Department . . . ”).

The filtered call record 434 includes no call center messages and is therefore ready for processing by a speech processor 430. The filtered call record 434 is passed to the speech processor 430 along with the query 226. The speech processor 430 performs speech recognition on the filtered call record 434 and determines if the recognized speech includes the query term 226. In this case, the speech recognizer determines that the filtered call record 434 includes the query term 226 (i.e., “Billing”) in the time interval of 0:50 to 0:51. The speech processor 430 passes this speech processing result 425 out of the searching and filtering module 424 and subsequently to the user 228.

The output 425 of the searching and filtering module 424 includes all identified putative instances of the query term 226 which are not associated with call center messages stored in the database of call center messages 216.

### 4 Alternatives

While the above description is specifically related to customer service call center applications, the searching and filtering module can be used in any other application where it is useful to identify unwanted portions of a multimedia recording and then exclude those unwanted portions from a query based search on the multimedia recording.

In the examples described above, the system searches for the call center messages and query terms in two separate steps. However, it is noted that in some examples, the two steps can be combined for efficiency purposes such that the call center messages and the query terms are searched for concurrently in the same step.

It is to be understood that the foregoing description is intended to illustrate and not to limit the scope of the invention, which is defined by the scope of the appended claims. Other embodiments are within the scope of the following claims.

### 5 Implementations

Systems that implement the techniques described above can be implemented in software, in firmware, in digital electronic circuitry, or in computer hardware, or in combinations of them. The system can include a computer program product tangibly embodied in a machine-readable storage device for execution by a programmable processor, and method steps can be performed by a programmable processor executing a program of instructions to perform functions by operating on input data and generating output. The system can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

What is claimed is:

1. A computer implemented method comprising:
receiving a query phrase;
receiving a first data representing a first audio signal comprising an interaction among a plurality of speakers and at least one segment of one or more known audio items;
receiving a second data comprising temporal locations of the at least one segment of one or more known audio items in the first audio signal;
searching the first data to identify putative instances of the query phrase that are temporally excluded from the temporal locations of the at least one segment of one or more known audio items.

2. The method of claim 1 further comprising determining the second data including receiving the first data representing the first audio signal, receiving a third data characterizing one or more known audio items, and searching the first data for the data characterizing one or more known audio items to identify temporal locations of the at least one segment of one or more known audio items in the first audio signal.

3. The method of claim 2 wherein the steps of searching the first data for the data characterizing one or more known audio items and searching the first data to identify putative instances of the query phrase are performed concurrently.

4. The method of claim 1 wherein searching the first data to indentify putative instances of the query phrase which are temporally excluded from the temporal locations of the at least one segment of one or more known audio items includes searching the entire audio signal to identify putative instances of the query phrase and disregarding at least some of the identified putative instances of the query phrase that have a temporal location coinciding with the temporal locations of the at least one segment of one or more known audio items.

5. The method of claim 1 wherein searching the first data to indentify putative instances of the query phrase that are temporally excluded from the temporal locations of the at least one segment of one or more known audio items includes searching only the parts of the first data that are excluded from the temporal locations of the at least one segment of one or more known audio items.

6. The method of claim 1 wherein each of the temporal locations of the at least one segment of one or more known audio items includes a time interval indicating a start time and an end time of a segment of an associated known audio item.

7. The method of claim 1 wherein each of the temporal locations of the at least one segment of one or more known audio items includes a timestamp indicating a start time of a segment of an associated known audio item and a duration of the segment of the associated known audio item.

8. The method of claim 1 wherein searching the first data to identify putative instances of the query phrase includes performing a phonetic searching operation on the first data.

9. The method of claim 8 wherein performing the phonetic searching operation includes performing a wordspotting operation.

10. The method of claim 1 wherein disregarding at least some of the identified putative instances of the query phrase which have a temporal location coinciding with the temporal locations of the at least one segment of one or more known audio items includes removing portions of the first audio signal which are associated with the temporal locations of the at least one segment of one or more known audio items prior to identifying putative instances of the query phrase.

11. The method of claim 1 wherein disregarding at least some of the identified putative instances of the query phrase which have a temporal location coinciding with the temporal locations of the at least one segment of one or more known audio items includes marking portions of the first audio signal which are associated with the temporal locations of the at least one segment of one or more known audio items; and skipping the marked sections when identifying the putative instances of the query phrase.

12. The method of claim 1 wherein the one or more known audio items include hold messages and interactive voice response (IVR) messages.

13. The method of claim 12 wherein the hold messages and IVR messages were automatically inserted into the first audio signal at a call center.

14. A system comprising:
an input for receiving a query phrase;
an input for receiving a first data representing a first audio signal comprising an interaction among a plurality of speakers and at least one segment of one or more known audio items;
an input for receiving a second data comprising temporal locations of the at least one segment of one or more known audio items in the first audio signal;
a speech processing module for searching the first data to identify putative instances of the query phrase; and
a filtering module for disregarding at least some of the identified putative instances of the query phrase which have a temporal location coinciding with the temporal locations of the at least one segment of one or more known audio items.

15. The system of claim 14 further comprising a multimedia spotting module for determining the second data including receiving the first data representing the first audio signal, receiving a third data characterizing one or more known audio items, and searching the first data for the data characterizing one or more known audio items to identify temporal locations of at least one segment of the one or more known audio items in the first audio signal.

16. The system of claim 14 wherein each of the temporal locations of the at least one segment of one or more known audio items includes a time interval indicating a start time and an end time of a segment of an associated known audio item.

17. The system of claim 14 wherein each of the temporal locations of the at least one segment of one or more known audio items includes a timestamp indicating a start time of a segment of an associated known audio item and a duration of the segment of the associated known audio item.

18. The system of claim 14 wherein the searching module is a phonetic searching module configured perform a phonetic searching operation on the first data.

19. The system of claim 18 wherein the searching module is a wordspotting engine configured to perform a wordspotting operation on the first data.

20. The system of claim 14 wherein the filtering module is configured to disregard at least some of the identified putative instances of the query phrase which have a temporal location coinciding with the temporal locations of the at least one segment of one or more known audio items including removing portions of the first audio signal which are associated with the temporal locations of the at least one segment of one or more known audio items prior to identifying putative instances of the query phrase.

21. The system of claim 14 wherein the filtering module is configured to disregard at least some of the identified putative instances of the query phrase which have a temporal location coinciding with the temporal locations of the at least one segment of one or more known audio items including marking portions of the first audio signal which are associated with the temporal locations of the at least one segment of one or more known audio items; and skipping the marked sections when identifying the putative instances of the query phrase.

22. The system of claim 14 wherein the one or more known audio items include hold messages and interactive voice response (IVR) messages.

23. The system of claim 22 wherein the hold messages and IVR messages were automatically inserted into the first audio signal at a call center.

24. Software stored on a computer readable medium comprising instructions for causing a data processing system to:
receive a query phrase;
receive a first data representing a first audio signal comprising an interaction among a plurality of speakers and at least one segment of one or more known audio items;
receive a second data comprising temporal locations of the at least one segment of one or more known audio items in the first audio signal;
search the first data to identify putative instances of the query phrase; and
disregard at least some of the identified putative instances of the query phrase which have a temporal location coinciding with the temporal locations of the at least one segment of one or more known audio items.
